(19) United States
(12) Patent Application Publication
(10) Pub. No.: US 2007/0124494 A1
(43) Pub. Date: May 31, 2007

(54) Method and apparatus to facilitate improving a perceived quality of experience with respect to delivery of a file transfer

(76) Inventor: John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/287,769

(22) Filed: Nov. 28, 2005

(51) Int. Cl. G06F 15/16

(52) U.S. Cl. 709/233

(57) ABSTRACT

One determines (101) an amount of initial delay as corresponds to delivery of a file transfer service from a source to a wireless communication system. When this amount of initial delay exceeds a predetermined duration (102), one then dynamically and automatically effects (103) a predetermined action to improve a perceived quality of experience with respect to the delivery of the file transfer service.

### TECHNICAL FIELD

This invention relates generally to the delivery of file transfer services and more particularly to the delivery of file transfer services to a wireless communication station.

### BACKGROUND

File transfer services of various kinds are known in the art. These include, though are not limited to, streaming services. Streaming content typically comprises audio, video, or audio/video information that is typically played back upon and during receipt (as distinguished, for example, from a file download where the file is typically downloaded in its entirety before being opened). Data packets transported using Internet Protocol (or the like) comprise a relatively common way to effect the provisioning of such content. In general, streaming content arrives more or less in an order by which the content should be played back.

As packet delivery processes are relatively jittery (thereby causing variable amounts of delay), generally time insensitive, and somewhat non-synchronized (such that it typically cannot be assured that the constituent packets will, in fact, arrive in their proper order), a receiving platform will typically buffer a predetermined quantity of received streaming content prior to initiating playback in order to likely ensure that playback, once commenced, will not be interrupted due to a momentary lack of sufficient streaming playback material/content.

At present, the user experience can vary greatly with respect to such file transfer services. In particular, the time between when the user requests delivery of content, such as streaming content, (or otherwise understands that such delivery is impending) and when the corresponding playback of that content actually begins can vary considerably. Such variations are often owing, at least in part, to dynamic transport conditions that impact, directly or indirectly, transport and playback latency. Such conditions can be particularly wide ranging when at least a portion of the bearer link comprises a wireless link (as when delivering content to, for example, a two-way wireless platform such as a cellular telephone and/or a push-to-talk transceiver).

Such variability can be disconcerting to a user and can detract, sometimes significantly, from the overall user experience. Testing a user's patience and expectations in this way can lead to user dissatisfaction, which dissatisfaction may be directed at the user's platform, the bearer network, and/or the file transfer service source itself. In other cases the user may become concerned or confused regarding the cause of latency and mistake such conditions for faulty equipment.

### BRIEF DESCRIPTION OF THE DRAWINGS

The above needs are at least partially met through provision of the method and apparatus to facilitate improving a perceived quality of experience with respect to delivery of a file transfer service described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one determines an amount of initial delay as corresponds to delivery of a file transfer service from a source to a wireless communication system. When this amount of initial delay exceeds a predetermined duration, one then dynamically and automatically effects a predetermined action to improve a perceived quality of experience with respect to the delivery of the file transfer service.

The amount of initial delay can be determined as a function of any of a wide variety of corresponding criteria and/or circumstances. Similarly, the predetermined action can vary with the needs and/or capabilities and opportunities that characterize a given application setting. Example predetermined actions include, though are not limited to, increasing a file transfer media bit rate, increasing a number of file transfer channels, reducing an amount of delay between when file transfer data begins to be transmitted by a source of the file transfer service and when the file transfer data begins to be rendered perceivable to a target end user of the file transfer service, and so forth. As yet another example, if desired, the predetermined action can comprise improving the radio link quality of service thus enabling modification of a buffer depth for a file transfer data playout buffer at the target.

So configured, these teachings provide considerable flexibility and opportunity to permit and facilitate capacity management within the source, network(s), and/or end user target that source, bear, or receive and utilize the file transfer service. Viewed generally, these teachings in particular permit an administrator to achieve informed dynamic configuration and setting of various quality of service factors based, at least in part, on anticipated setup delay. As one example in this regard, these teachings facilitate at least an attempt to substantially normalize when a given file transfer service begins to be rendered perceivable to an end user of a target platform notwithstanding considerable variations with respect to the corresponding amount of initial delay.

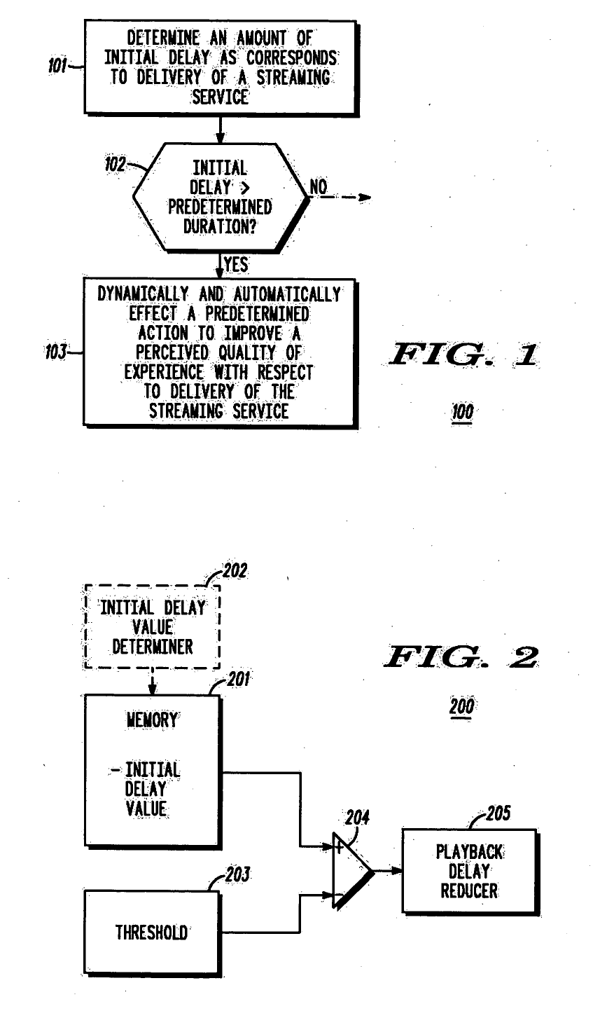

These and other benefits may become clearer upon making a thorough review and study of the following detailed description. For the sake of simplicity and clarity, the illustrative examples provided herein refer to a streaming service context. Those skilled in the art, however, will readily understand and appreciate that these teachings are similarly applicable for use with a variety of file transfer services and that all references herein to “streaming services” refer as well in a broader sense to file transfer services in general. Referring now to the drawings, and in particular to FIG. 1, an illustrative process 100 may be effected by an implementation platform. Those skilled in the art, will recognize and understand that such a process 100 can be readily implemented by any of a large number and variety of such platforms as may best suit the needs and requirements of a given context. Example platforms include, but are certainly not limited to, the source of the streaming service (regardless of whether the source comprises a network element such as a streaming service server, a wireless communication station, and so forth), the target platform itself (such as a wireless communication station), or even the intervening bearer network (such as, for example, a wireless communication system that will serve to convey, at least in part, the streamable data from the source to the target).

This process 100 provides for determining 101 an amount of initial delay as corresponds to delivery of a streaming service from a source to a wireless communication station. Such determination, by one approach, generally comprises anticipating, detecting, and/or measuring a particular amount of initial delay as is likely to be experienced in a given instance. In some cases, for example, this measurement can be taken after the initial phase of session set-up has been completed. Those skilled in the art will recognize that such an amount can be so anticipated in any of a wide variety of ways. Some examples comprise (but are not limited to):
an anticipated time by when a wireless communication station enters a state of operability that will permit reception of the streaming service;
a state of a channel as will serve to convey at least a portion of the streaming service to a wireless communication station (where “convey” shall be understood to comprise transmission of the streaming service and/or reception of the streaming service);
a state of a mobile station as comprises the target recipient of the streaming service (for example, if a target mobile station is presently in a tighter mobility tracking state, this circumstance may tend to reduce delay as the source (or a conveyance element acting on behalf of the source) has current information regarding a present location of the target mobile station and thus a bearer channel can be immediately assigned without first having to page in order to locate the target mobile station);
a timestamp as accompanies a transmission originated by the source (when such, of course, is available either to specifically support these teachings or otherwise);
a present location of a talker arbitration judge (for example, when a floor control arbitration judge as is otherwise known in the art is dynamically moved from location to location and thereby contributes to variations with respect to an amount of time as may be required in a given instance to initialize delivery of a specific streaming service);
the radio frequency technology being used by each of the source and the wireless communication station (to reflect and take into account, for example, delay as may arise when a given wireless communication station utilizes a slower-than-normal radio frequency technology due to platform limitations, anecdotal system coverage and/or capacity issues, and so forth);
success of at least one of an initial and subsequent access probe (to reflect and take into account, for example, when additional delay may be anticipated due to a present or recent necessity of utilizing a plurality of access probes in order to successfully contact the target wireless communication station, or additional delay that may be anticipated due to a present or recent necessity of utilizing a plurality of access probes in order to successfully initiate a call by a device or to successfully respond by a device/target);
success of at least one of an initial and subsequent paging channel message (to reflect and take into account, for example, when additional delay may be anticipated due to a present or recent necessity of utilizing a plurality of paging probes in order to successfully contact the wireless infrastructure, or additional delay that may be anticipated due to a present or recent necessity of utilizing a plurality of paging channel messages in order to successfully establish a call with the device);
success of a communication session initiation process (to reflect and take into account, for example, when an initial message as is transmitted on a downlink common channel (such as a page or channel assignment message) becomes lost and requires retransmission);
at least one of a paging interval and slot cycle index or time between target wake-up times to check for pages;
an offset of a target mobile's wake-up time (to reflect and to take into account that the specific wake-up time offset for a given target wireless communication station can impact the delay of concern (for example, in a case when a specific call is temporally positioned appropriately, little delay may be anticipated notwithstanding that the target wireless communication station only wakes up every five seconds while in another case the call may be temporally positioned such that essentially all of this offset delay will likely add and contribute to the overall initial delay before the target user can begin to perceive playback of the streaming content);
a state of each participant within a group call including an originator and each target (to aid in taking into account situations where multiple intended recipients of a streaming service are going to likely wake up at different times from one another, or where some targets are active or otherwise already on a traffic channel while other targets are inactive or not otherwise already on a traffic channel);
   to note but a few relevant examples.

Having determined 101 the amount of initial delay, the process 100 then determines 102 whether the amount of initial delay exceeds a predetermined duration of choice. The predetermined duration can vary with the needs of a given application setting. It would also be possible for a plurality of candidate predetermined durations to be available for dynamic selection using a selection process or criterion of choice (to permit, for example, using varying amounts as correspond to different quality of service levels to which given end users might subscribe). By one approach the predetermined duration correlates to a maximum delay that a system administrator deems acceptable.

When the determined initial delay does not exceed the predetermined duration, the process 100 may accommodate whatever subsequent processing and handling a given application setting may provide. When, however, the determined initial delay exceeds the predetermined duration, the process 100 then provides for dynamically and automatically effecting 103 a predetermined action to improve a perceived quality of experience with respect to the delivery of the streaming service. The specific predetermined action to so effect will likely vary with the needs and/or opportunities as characterize a given system. Some examples of potentially useful predetermined actions comprise:
increasing a streaming media bit rate (such as, for example, by increasing a bit rate for a vocoder, increasing video resolution, and so forth);
increasing a number of streaming channels (such as, for example, by including both a left and right audio channel instead of only a single audio channel or the like);
reducing an amount of initial delay between when streaming data begins to be transmitted by a source of the streaming service and when the streaming data begins to be rendered perceivable to a target end user of the streaming service;
   to note only a few illustrative examples.

Generally speaking, and so configured, those skilled in the art will see that an end user who is likely to experience an undue delay (for example, when undue delay is anticipated as a result of a relatively low bit rate or a relatively higher number of retransmissions as may be expected in order to set up a specific kind of call such as a push-to-talk call) with respect to being able to experience their corresponding streaming content may be provided with an experiential compensating trade off. By some of these approaches, as when the streaming media bit rate of the number of streaming channels is increased, the end user is effectively compensated with one form of quality of service when another quality of service aspect (i.e., playback establishment latency) exceeds pre-established bounds. By other approaches, as when the amount of initial delay is, itself, reduced, the end user is proactively protected, at least to some degree, with respect to such service establishment.

Accordingly, for example, the predetermined action can comprise requesting an increased level of bearer channel quality of service to be used when conveying the streaming data to the target end user. This, of course, can be accomplished using any of a wide variety of implementing techniques. Some specific examples comprise, but are not limited to, requesting and/or being accorded:
an improved Frame Erasure Rate (FER) as is known in the art;
an improved data transmission priority level;
an increased paging probe power level;
an improved access probe level (where an “access probe” will be understood to refer to an initial message as is sent by a formerly dormant mobile station to a network point-of-attachment (such as a base station));
delivery of a communication invitation to the end user target via a normal telephony channel exhibiting higher reliability and less jitter as versus, for example, a system control channel as might otherwise ordinarily be employed for this purpose (via, for example, a push-to-talk channel) (to thereby, for example, effect delivery of that invitation or call content/media at an earlier time than would otherwise be expected when using the system control channel);
delivery of a communication invitation to the end user target via a normal telephony channel as versus a system overhead channel (such as, but not limited to, a system control channel) as might otherwise be employed for this purpose;
adjustment of a number of frames of vocoding data as are to be provided per packet (by decreasing, for example, the number of frames so provided (where decreasing the number of vocoded frames per packet decreases delay but increases the service-level bit rate because more packet headers must be sent per second of content));
adjustment of a vocoding parameter (to thereby, for example, effect provision of a higher quality of voice service);
adjustment of at least one of an image and a video representation parameter (for example, by improving the resolution of a video or image or the number frames per second as are employed to convey the video information);
an increase of Automatic Repeat request (ARQ) persistence to thereby lower frame/packet loss probability;
adjustment of a scheduler jitter/latency requirement to thereby make the requirement more stringent;
use of direct delivery over a paging channel (where “direct delivery” shall be understood to refer to a first received message that itself comprises either the message itself or a channel assignment);
an increased power level;
an increased amount of redundancy;
an increased wireless link quality of service;
use of a faster and/or more reliable radio frequency technology that increases, for example, power usage, redundancy, and/or decreases jitter for the end user target (where, for example, a faster or more reliable candidate radio frequency technology offers a speed improvement such as a faster bit transmission rate, faster call establishment capabilities, and so forth);
   and so forth, to name but a few.

The techniques listed immediately above tend, for the most part, to attempt to compensate for a determined undue delay by providing, in some other manner, an improved experience for the target end user to at least attempt, in both an objective and a subjective manner, to normalize an overall perception of service for the target end user. As has been noted above and consistent with these teachings, one may also seek, in combination with such techniques as are listed above or in lieu thereof, to in fact ameliorate or otherwise reduce the total/overall initial delay that the target end user in fact experiences.

As one example in this regard, the predetermined action can comprise, at least in part, modifying a buffer depth (such as a playout buffer depth) at the end user target. More particularly, such modification can comprise adjusting the buffer to a shallower depth such that streaming data playout will begin earlier than might otherwise be the case, leveraging the better wireless channel quality of service. For example, a playout buffer at the end user target might ordinarily require at least 1000 ms of audio content to have been buffered before playback will commence. When the initial delay that is likely going to be experienced by a given target end user equals, for example, 2 seconds, by these teachings one may dynamically and automatically modify this buffer depth requirement to instead only require having buffered, say, 200 ms of audio content before permitting playback. So configured, and notwithstanding that other system conditions as might be contributing to an increased delay with respect to provision of the streaming content to the end user target, by this approach the end user may nevertheless remain unaware of such conditions as the playback appears to begin within about the same period of time as the end user might otherwise expect. This result occurs, at least in part, by normalizing at least to some extent the user's experience perceptions with respect to such playout.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided. As will be well appreciated by those skilled in the art, this illustrative apparatus 200 may comprise, for example, a streaming content source, an end user target such as a wireless communication station, a communication system (such as a wireless communication system that serves to convey, at least in part, streamable content from the source to the target end user, or some combination thereof depending upon the needs and/or desires of a given designer. Accordingly, and for purposes of illustration and not limitation, this apparatus 200 may comprise, in whole or in part, any of a push-to-talk server, a telephone, a personal computer, a television receiver, a Community Access Television (CATV) receiver, or any wireless communication system that serves to convey, at least in part, streamable data from a source to a wireless communication station.

In this illustrative embodiment, the apparatus 200 comprises a memory 201 having an initial delay value stored therein wherein the initial delay value corresponds to an amount of initial delay as corresponds to delivery of a streaming service from a source to an end user target. As noted above this initial delay value represents an anticipated period of delay. This period of delay may be known or calculated with varying degrees of assurance and accuracy and still remain consistent and compatible with these teachings. By one optional approach, this apparatus 200 further comprises an initial delay value determiner 202. This initial delay value determiner 202 can determine the initial delay value as is stored in the memory 201 using, for example, any of the corresponding approaches and/or criteria set forth in detail above. This initial delay value determiner 202 will further likely be configured and arranged to be able to facilitate storage of such a determined initial delay value in the memory 201.

This apparatus 200 further comprises a threshold 203 that is stored, for example, in memory either integral to or physically discrete from the aforementioned memory 201 as may best accord with the wishes and needs of a given designer. As noted above, this can comprise a single threshold value that the apparatus 200 employs over a variety of operational needs or may comprise a plurality of different thresholds that are individually selected for use as appropriate using selection criteria of choice.

A comparator 204 operably couples to the memory 201 and the threshold 203 and serves to compare the threshold with the initial delay value in order to provide an output that corresponds to a difference between the value that corresponds to the amount of delay and the stored threshold. A playback delay reducer 205 responds to this output and is configured and arranged (via, for example, programming that accords with the teachings presented above) to dynamically and automatically improve at least an aspect of user experience quality when the amount of initial delay exceeds a predetermined duration represented, in this illustrative embodiment, by the threshold. Such improvement can comprise, as noted above, effecting a predetermined action whereby, for example, another perceivable aspect of the user experience is improved and/or by in fact reducing the amount of delay that will be experienced by the target end user.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, as already noted, these teachings are suitable for use with a variety of file transfer services. To illustrate by way of example, a given end user may employ their mobile station to seek information regarding a time at which a next train bound for a specific destination will arrive. If and as that mobile station experiences, for example, some probe failures with respect to initially trying to connect to the network, a higher bit rate channel with better quality of service than is usual may be allocated so that the overall user's perception of their experience is not unduly altered or negatively impacted.

I claim:

1. A method comprising:
determining an amount of initial delay as corresponds to delivery of a file transfer service from a source to a wireless communication station;
when the amount of initial delay exceeds a predetermined duration, dynamically and automatically effecting a predetermined action to improve a perceived quality of experience with respect to the delivery of the file transfer service.

2. The method of claim 1 wherein the predetermined action comprises at least one of the following:
increasing a file transfer media bit rate
increasing a number of file transfer channels;
reducing an amount of delay between when file transfer data begins to be transmitted by a source of the file transfer service and when the file transfer data begins to be rendered perceivable to a target of the file transfer service.

3. The method of claim 1 wherein the source comprises another wireless communication station.

4. The method of claim 1 wherein determining an amount of initial delay as corresponds to delivery of a file transfer service from a source to a wireless communication station comprises determining the amount of initial delay as a function, at least in part, of at least one of:
an anticipated time by when a wireless communication station enters a state of operability that will permit reception of the file transfer service;
a state of a channel as will serve to convey at least a portion of the file transfer service to a wireless communication station;
a state of a mobile station as comprises the target recipient of the file transfer service;
a timestamp as accompanies a transmission originated by the source;
a present location of a talker arbitration judge;
radio frequency technology being used by each of the source and the wireless communication station;
success of at least one of an initial and subsequent access probe;
success of at least one of an initial and subsequent paging channel message;
success of a communication session initiation process;
at least one of a paging interval and slot cycle index or time between target wake-up times to check for pages;
an offset of a target mobile's wake-up time;
a state of each participant within a group call including an originator and each target.

5. The method of claim 1 wherein determining an amount of initial delay as corresponds to delivery of a file transfer service from a source to a wireless communication station and, when the amount of initial delay exceeds a predetermined duration, dynamically and automatically effecting a predetermined action further comprises determining the amount of initial delay and effecting the predetermined action at at least one of:
the source;
the wireless communication station;
a wireless communication system that will serve to convey, at least in part, the streamable data from the source to the wireless communication station.

6. The method of claim 1 wherein the predetermined action comprises requesting an increased level of bearer channel quality of service to be used when conveying the file transfer data to the wireless communication station.

7. The method of claim 6 wherein the predetermined action comprises at least one of:
an improved Frame Erasure Rate (FER);
an improved data transmission priority level;
an increased paging probe power level;
an improved access probe level;
delivery of a communication invitation to the wireless communication station via a normal telephony channel exhibiting higher reliability and less jitter as versus a system control channel as might otherwise ordinarily be employed for this purpose;
delivery of a communication invitation to the wireless communication station via a normal telephony channel as versus a system overhead channel as might otherwise be employed for this purpose;
adjustment of a number of frames of vocoding data as are to be provided per packet;
adjustment of a vocoding parameter;
adjustment of at least one of an image and a video representation parameter;
an increase of Automatic Repeat reQuest (ARQ) persistence to thereby lower frame/packet loss probability;
adjustment of a scheduler jitter/latency requirement to thereby make the requirement more stringent;
use of direct delivery over a paging channel;
an increased power level;
an increased amount of redundancy;
an increased wireless link quality of service;
use of a faster radio frequency technology for the wireless communication station;
use of a more reliable radio frequency technology for the end user target.

8. The method of claim 1 wherein the predetermined action comprises modifying a buffer depth for a file transfer data playout buffer at the wireless communication station.

9. The method of claim 8 wherein modifying a buffer depth for a file transfer data playout buffer at the wireless communication station comprises at least attempting to substantially normalize when the file transfer data begins to be rendered perceivable to a user of the wireless communication notwithstanding an amount of delay that exceeds the predetermined duration.

10. The method of claim 8 wherein modifying a buffer depth for a file transfer data playout buffer at the wireless communication station comprises adjusting the buffer depth to a shallower depth such that file transfer data playout will begin earlier.

11. An apparatus comprising:
a memory having a value stored therein corresponding to an amount of initial delay as corresponds to delivery of a file transfer service from a source to a wireless communication station;
at least one stored threshold;
a comparator operably coupled to the memory and the at least one stored threshold and having an output that corresponds to a difference between the value that corresponds to the amount of delay and the stored threshold;
a playback delay reducer that is responsive to the comparator and that is configured and arranged, when the amount of initial delay exceeds a predetermined duration, to dynamically and automatically improve user experience quality by effecting a predetermined action comprising at least one of the following:
increasing a file transfer media bit rate
increasing a number of file transfer channels;
reducing an amount of delay between when file transfer data begins to be transmitted by a source of the file transfer service and when the file transfer data begins to be rendered perceivable to a target of the file transfer service.

12. The apparatus of claim 11 wherein the source comprises another wireless communication station.

13. The apparatus of claim 11 and further comprising means for determining the value as a function, at least in part, of at least one of:
an anticipated time by when a wireless communication station enters a state of operability that will permit reception of the file transfer service;
a state of a channel as will serve to convey at least a portion of the file transfer service to a wireless communication station;
a state of a mobile station as comprises the target recipient of the file transfer service;
a timestamp as accompanies a transmission originated by the source;
a present location of a talker arbitration judge;
radio frequency technology being used by each of the source and the wireless communication station;
success of at least one of an initial and subsequent access probe;
success of at least one of an initial and subsequent paging channel message;
success of a communication session initiation process;
at least one of a paging interval and slot cycle index or time between target wake-up times to check for pages;
an offset of a target mobile's wake-up time; a state of each participant within a group call including an originator and each target.

14. The apparatus of claim 11 wherein the apparatus comprises at least one of:
the source;
the wireless communication station;
a push-to-talk server;
a telephone;
a personal computer;
a television receiver;
a Community Access Television (CATV) receiver;
a wireless communication system that will serve to convey, at least in part, the streamable data from the source to the wireless communication station.

15. The apparatus of claim 11 wherein the predetermined action comprises requesting an increased level of bearer channel quality of service to be used when conveying the file transfer data to the wireless communication station.

16. The apparatus of claim 15 wherein the predetermined action comprises at least one of:
an improved Frame Erasure Rate (FER);
an improved data transmission priority level;
an increased paging probe power level;
an improved access probe level;
delivery of a communication invitation to the wireless communication station via a normal telephony channel exhibiting higher reliability and less jitter as versus a system control channel as might otherwise ordinarily be employed for this purpose;
delivery of a communication invitation to the wireless communication station via a normal telephony channel as versus a system overhead channel as might otherwise be employed for this purpose;
adjustment of a number of frames of vocoding data as are to be provided per packet;
adjustment of a vocoding parameter;
adjustment of at least one of an image and a video representation parameter;
an increase of Automatic Repeat reQuest (ARQ) persistence to thereby lower frame/packet loss probability;
adjustment of a scheduler jitter/latency requirement to thereby make the requirement more stringent;
use of direct delivery over a paging channel;
an increased power level;
an increased amount of redundancy;
an increased wireless link quality of service;
use of a faster radio frequency technology for the wireless communication station; use of a more reliable radio frequency technology for the end user target.

17. The apparatus of claim 11 wherein the predetermined action comprises modifying a buffer depth for a file transfer data playout buffer at the wireless communication station.

18. The apparatus of claim 17 wherein modifying a buffer depth for a file transfer data playout buffer at the wireless communication station comprises at least attempting to substantially normalize when the file transfer service begins to be rendered perceivable to a user of the wireless communication notwithstanding an amount of delay that exceeds the predetermined duration.

19. The apparatus of claim 17 wherein modifying a buffer depth for a file transfer data playout buffer at the wireless communication station comprises adjusting the buffer depth to a shallower depth such that file transfer service playout will begin earlier.
